(19) United States
(12) Patent Application Publication
(10) Pub. No.: US 2019/0120440 A1
(43) Pub. Date: Apr. 25, 2019

(54) LED LIGHT-BULB SYSTEM FOR LINEAR LIGHT FIXTURES

(71) Applicant: GREEN CREATIVE, LTD, Hong Kong (CN)

(72) Inventor: Daniel Arthur Kroencke, Winter Park, FL (US)

(73) Assignee: GREEN CREATIVE, LTD, Hong Kong (CN)

(21) Appl. No.: 15/998,290

(22) Filed: Jul. 31, 2018

Related U.S. Application Data
(60) Provisional application No. 62/707,235, filed on Oct. 25, 2017.

(51) Int. Cl. F21K 9/272; F21K 9/278; F21V 23/06

(52) U.S. Cl. CPC F21K 9/272; F21Y 2103/10; F21V 23/06; F21K 9/278

(57) ABSTRACT

The present invention is directed to a linear LED light fixture system. The system includes a LED light engine with curved or angled elbow bracket or end pieces having clip ends that fit into and secure within matched holder apertures of a linear light fixtures. The LED light engine preferably includes a linear housing with an internal array of LEDs and a LED driver circuit that electrically couples to power source through the angled elbow bracket or end pieces. The system is used in new linear LED light fixtures and or is used for converting fluorescent linear light fixtures into linear LED light fixtures.

### RELATED APPLICATION

This application claims priority under 35 U.S.C. § 119(e) from the co-pending U.S. provisional patent application Ser. No. 62/707,235, filed on Oct. 25, 2017, and titled “LED LIGHT-BULB SYSTEM FOR TROFFER-TYPE LIGHT FIXTURES.” The co-pending U.S. provisional patent application Ser. No. 62/707,235, filed on Oct. 25, 2017, and titled “LED LIGHT-BULB SYSTEM FOR TROFFER-TYPE LIGHT FIXTURES” is hereby incorporated by reference.

### FIELD OF THE INVENTION

This invention is related to LED lighting. More specifically, this invention is related to an system for attaching linear LED light engines to new or existing linear light fixtures.

### BACKGROUND OF THE INVENTION

Low-profile, recessed or suspended linear tube light fixtures, including high-bay, wrap, low-bay, troffer and strip light fixtures, have been the industry standard for providing light to large area work spaces, such as schools and offices. Conventional linear tube light fixtures use fluorescent tube light engines. There is a push to replace fluorescent lighting with more efficient LED lighting solutions.

Linear light engines, including linear LED light engines, are often attached to light fixtures through bi-pin lamp holder mechanisms which can be cumbersome to engaged during replacement of the light engine. Further, replacing fluorescent linear light fixtures can be expensive and cause structural damage to ceilings and/or walls. As an alternative to replacing fluorescent linear light fixtures, conversion systems can be used to retrofit older linear tube lighting to accommodate more efficient LED light engines.

### SUMMARY OF INVENTION

The present invention is direct directed to new light fixtures with linear LED light engines that attach to the body of the light fixture through elbow-type brackets with or without electrical connectors. The elbow-type brackets make replacement of linear LED light engines efficient. The present invention is also direct to the a retro-fit kit, whereby bi-pin lamp holder mechanisms are replaced with the elbow-type brackets with or without electrical connectors to convert fluorescent tube-based linear light fixtures to accommodate linear LED light engines. It is understood that, the linear LED light engines may only requires electrical connection on one end of the light engine.

The system of the present invention includes a linear LED light engine with elbow brackets or end pieces. The elbow brackets or end pieces have rectangular clip ends, curved mid-sections, body portions and adapter ends. The adapter ends couple to, or attach to, opposed ends of a linear LED light engine body or housing. Electrical connections pass from power connections within the linear light fixture housing and through the elbow brackets or end pieces to power the linear LED light engine. The body portions of the elbow brackets or end pieces and the linear LED light engine housing are preferably made from plastic, but portions thereof can be formed from other materials or combinations of materials, such as metal, rubber and other polymeric or resin materials. While the linear LED light engine is described herein as being formed in parts, it will be clear to one skilled in the art that the elbow brackets and the linear LED light engine body or housing can be monolithic.

As mentions above, the elbow brackets or end pieces are used in the construction of new light fixtures or are used to convert existing fluorescent tube-based light fixtures to accommodate liner LED light engines, such as described below. While the linear LED light engine body is shown herein as being tubular with a circular cross-section, any cross-sectional shape is envisioned including, but not limited to, square, rectangular, triangular and irregular cross-sectional shapes.

Fluorescent tube-based light fixtures, usually include a square or rectangular body or housing. The housing encloses electrical components of the light fixture, such ballasts, connections and any other electrical components required to operate the light fixture. Typically, bi-pin lamp holders that are electrically coupled to a ballast pass through rectangular apertures on a housing cover and are used to hold fluorescent tube light engines and power fluorescent tube light engines via pin contacts that protrude from opposed ends of the fluorescent tube light engines.

Where the system of the present invention is used to covert existing fluorescent tube-based light fixtures to accommodate linear LED light engines, the pin-based lamp holders are removed from the housing of an existing strip light fixture leaving behind power wire connections and apertures indentations on the housing cover. Apertures herein refer to holes that are surrounded by material that form the housing cover and indentations refer to cut-out structures at ends of the housing cover. The apertures or indentations on the housing cover are usually rectangular in shape, however, other shapes are also envisioned. Regardless of the shape of the apertures or indentations, clip ends of the elbow brackets are constructed to match the other the shape of the apertures of indentations and, therefore, are referred to herein as matched clip ends and matched apertures or indentations. Matched clip ends and or matched apertures or indentations are often rectangular

The linear LED light engine of the present invention is coupled to the housing of the linear light fixture by placing the matched clip ends into the rectangular apertures or indentations to thereby secure the linear LED light engine in place. Prior to coupling the linear LED light engine to the linear light housing or after coupling the linear LED light engine to the linear light housing, the required wire connections are made to provide power linear LED light engine.

### BRIEF DESCRIPTION OF THE DRAWINGS

FIGS. 1A-E show views of an elbow bracket or end piece used to secure an linear LED light engine to a linear light fixture housing, in accordance with the embodiments of the invention.

FIGS. 2A-B show a perspective view and a cross-sectional view of a linear LED light engine body or housing, in accordance with the embodiments of the invention.

FIG. 3A shows an exploded view a fluorescent tube strip light fixture.

FIG. 3B shows a schematic representation of a linear LED light engine installed in a housing structure of a linear light fixture, in accordance with the embodiments of the invention.

FIG. 4 show electrical connections used to power a linear LED light engine through elbow brackets or end pieces, in accordance with the embodiments of the invention.

### DETAILED DESCRIPTION OF THE INVENTION

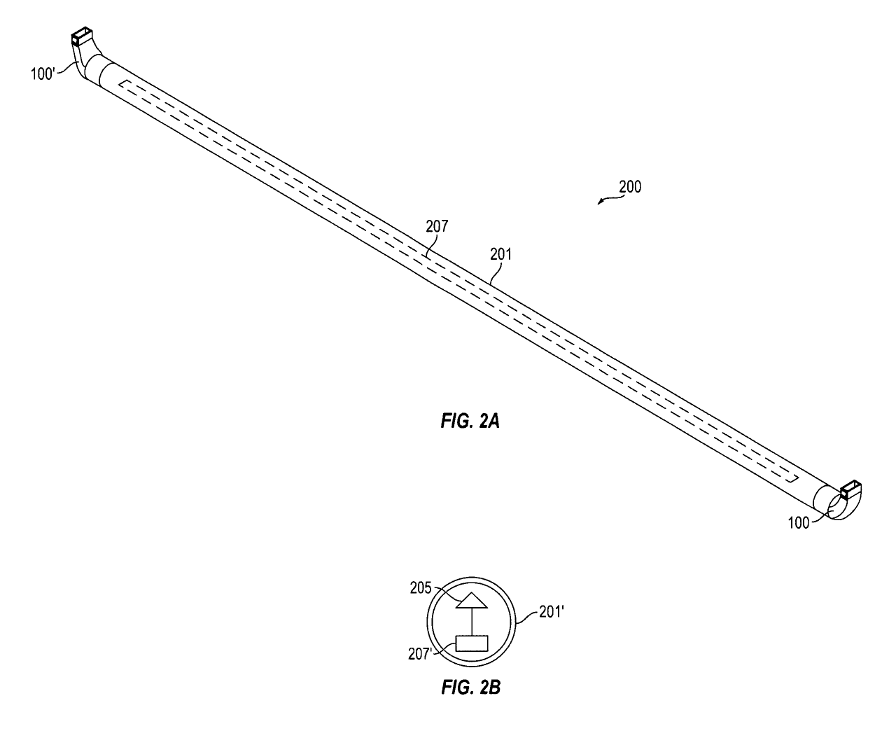

A linear LED light engine 200 (FIG. 2A) of the present invention includes elbow brackets or end pieces that can be used to replace typical pin-based lamp holders of fluorescent tube linear fixtures or be used in the construction of new linear LED light fixtures. The linear LED light engine 200 is used in the manufacturing of new or for retro-fitting flourescent tube light fixtures including, but not limited to, low-profile light fixtures, recessed or suspended light fixtures, high-bay light fixtures, wrap light fixtures, low-bay light fixtures, troffer-type light fixtures and strip light fixtures.

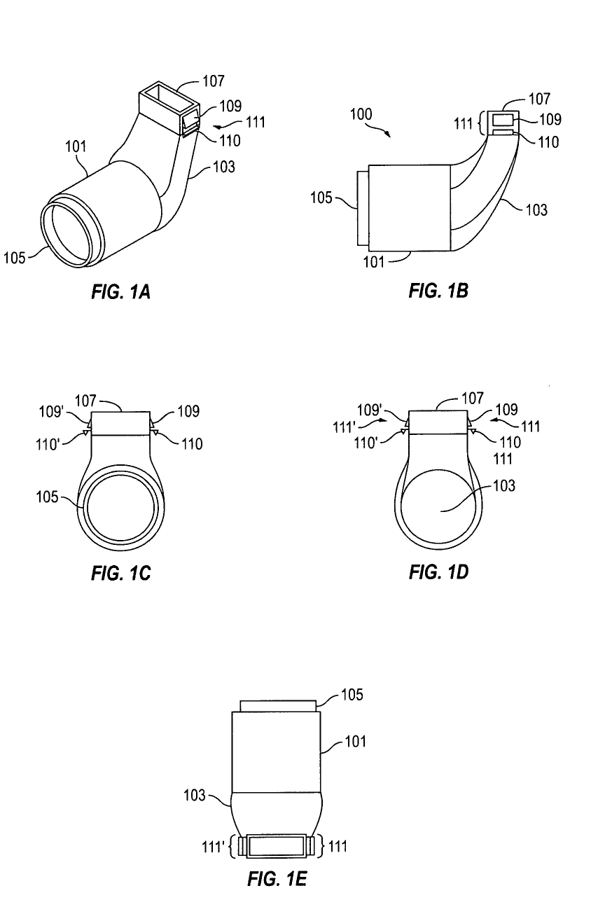

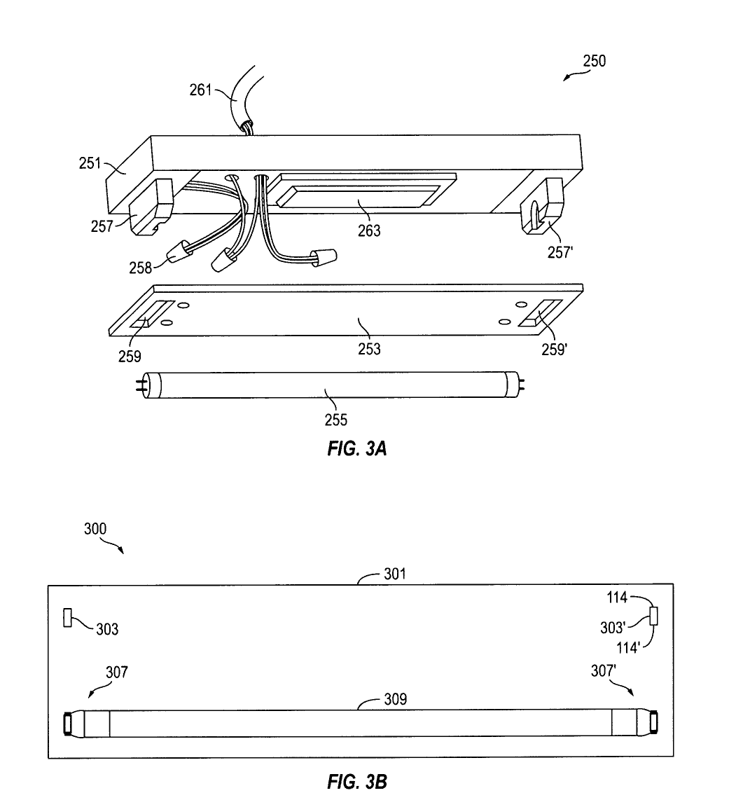

Referring to FIGS. 1A-E, each elbow bracket or end piece 100 is curved or angled as shown. The elbow bracket or end piece 100 has a fitted clip end 107 (that can be rectangular), a curved or angled mid-section 103, a body portion 101 and an adapter end 105. The fitted clip end 107 preferably has two opposed clips mechanisms 111 and 111′. The clip mechanisms 111 and 111′ include side clips 109 and 109′ that secure or lock the elbow bracket or end piece 100 within a aperture or indentation on a top inner surface of a housing cover of a strip light fixture housing structure. Apertures herein refer to holes that are surrounded by material that form the housing cover and indentations refer to cut-out structures at ends of the housing cover. The apertures or indentations on the housing cover are usually rectangular in shape, but be any number of shapes.

Where the present invention is being used to convert and existing fluorescent tube linear fixture to accommodate a linear LED light engine, there are rectangular apertures or indentations on a top inner surface of a housing cover where a pin-based lamp holders have been remove from. Opposed side clips 109 and 109′ that are, for example, living hinge clips or other clips are compress or collapse when pushed through the rectangular apertures or indentations and re-expand after passing through the rectangular aperture or indentation. The clips mechanisms 111 and 111′, also preferably include clip stops 110 and 110′ that prevent the rectangular clip ends 107 from going too far into the rectangular apertures or indentations. With the rectangular clip ends 107 properly engaged within the rectangular apertures or indentations of the housing cover, edges 114 and 114′ (FIG. 3B) around the rectangular aperture or indentation of the housing cover are sandwiched between the side clips 109 and 109′ and the clip stops 110 and 110′.

Referring now to FIGS. 2A-B, two elbow brackets or end pieces 100 and 100′ couple to a linear LED light engine body or housing 201 through their respective adapter ends 105. The linear LED light engine body or housing 201 is shown to have a round-shaped cross-section 201′, however, other cross-sectional shapes are contemplated including, but not limited to, oval, square, rectangular and triangular and irregular shaped cross-sectional shapes. And while the preferred material for fabricating the elbow brackets or end pieces 100 and 100′ and the linear LED light engine body or housing 201 is plastic, the elbow brackets or end pieces 100 and 100′ and portions of the linear LED light engine housing 201 can be formed from other suitable materials.

The linear LED light engine 200 can include any number of arrays of LEDs 207 that extend throughout the linear LED light engine body or housing 201. Also, the linear LED light engine 200 of the present invention includes an LED driver circuit 205 that is electrically coupled to the array of LEDs 207 and is powered through electrical connections originating from any of the two elbow brackets or end pieces 100 and 100′, as described below. The LED driver circuit 205 can be contained within the linear LED light engine body as shown or can be attached to and/or installed on the linear light fixture housing 251 (FIG. 3A).

FIG. 3 shows an exploded view a fluorescent tube linear light fixture 250. The linear light fixture 250 includes a housing structure with a housing body 251 with power wires 261 that pass through the housing. The power wires 261 electrically couple to a ballast 263. The ballast 263 has electrical connections 258 that couple to two opposed pin-based lamp holders 257 and 257′. The housing structure also includes a housing cover 253 with rectangular apertures 259 and 259′. The housing cover attaches to the housing body 251 with the pin-based lamp holders 257 and 257′ passing through the rectangular apertures 259 and 259′. In operation the a fluorescent tube light engine 255 is couple to the pin-based lamp holders 257 and 257′ with the housing cover 253 attached to the housing body 251 and the fluorescent tube light engine 255 is energized or powered through the ballast.

In the present invention, and where the invention is used to convert fluorescent tube linear light fixture 250 to accommodate a linear LED light engine, the housing cover 253 is removed from the housing body 251 and the pin-based lamp holders 257 and 257′ are removed from and existing strip light fixture 250. Where necessary, the ballast 263 is disconnected and/or removed and an LED driver circuit can be installed, unless the LED driver circuit 205 is positioned within the linear LED light engine body or housing 201. Regardless of where the LED driver circuit is located, the removal of the pin-based lamp holders 257 and 257′ results in vacated rectangular apertures or indentations 259 and 259′, such as decided above. The linear LED light engine 200 is installed by placing the clip ends 107 (FIG. 1) of both two elbow brackets or end pieces 100 and 100′ into the rectangular apertures 259 and 259′ until the clip mechanisms engage edges 114 and 114 (FIG. 3B) around the rectangular apertures or indentations 259 and 259′. Prior to installing linear LED light engine 200 or after installing the linear LED light engine 200 into the rectangular apertures or indentations 259 and 259′, new or existing wiring is used to connect the linear LED light engine 200 to a power source through at one or both of the elbow brackets or end pieces 100 and 100′

FIG. 3B shows schematic diagram 300 of a housing cover 301, such as the housing cover 253 described above. The housing cover 301 includes sets of opposed rectangular apertures 303 and 303′. After the appropriate wiring is provided, a linear LED light engine 200 is installed by placing rectangular clip ends 107 (FIGS. 1A-E) of the elbow brackets or end pieces 100 and 100′ (FIG. 2A) into a set of opposed rectangular apertures 303 and 303′. As described above, the two opposed side clips 109 and 109′ on each of the elbow brackets or end pieces 100 and 100′ pass through the rectangular apertures 303 and 303′ and secure the linear LED light engine 200 in position with two opposed side clips 109 and 109′ engaging edges 114 and 114′ of the rectangular apertures 303 and 303′. FIG. 3B also shows a linear LED light engine 309 installed with two rectangular clips ends 307 and 307′ of the elbow brackets or end pieces inserted into a set opposed rectangular apertures.

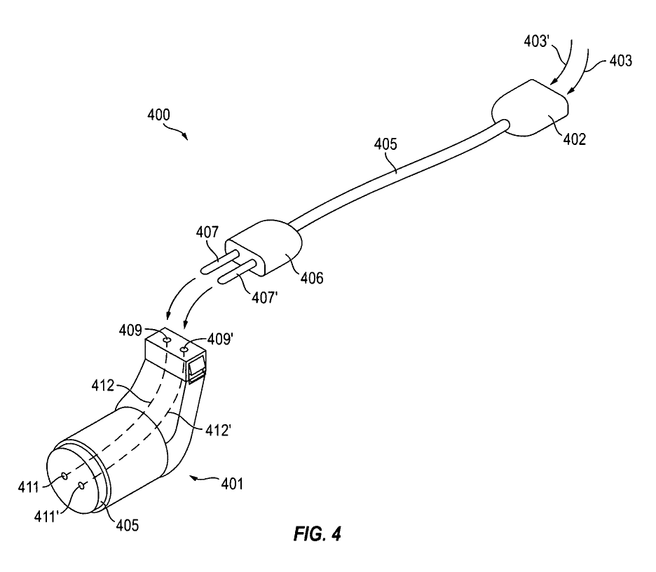

Now referring to FIG. 4, any number of wiring configuration are envisioned including using wire nuts. In accordance with an embodiment of the invention the system of the present invention includes a quick connect chord 405. The quick connect chord included a female end 402 that is configured to receive two or more electrical wires, as indicated by the arrows 403 and 403′. The quick connect chord 405 also include a male end 406 with two pin connectors 407 and 407′. The pin connectors 407 and 407′ are configured to be inserted into connection receptors 409 and 409 on the rectangular clip end of an elbow bracket or end piece 401, such as the elbow bracket or end piece described above. Wires 412 and 412′ pass through the elbow bracket or end piece 401 and terminate with contacts 411 and 411′ at an adapter end 405 of the elbow bracket or end piece 401. The contacts 411 and 411 are in electrical communication with the array of LEDs 207 and/or the LED driver circuit 205 (FIG. 2B) to power the linear LED light engine 200 (FIG. 2A)

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A linear LED light system comprising:
a) elbow or end pieces each with adapter ends and clip ends, wherein the clip ends fit into apertures of a housing cover of the strip light fixture after pin-based lamp holders are removed from the strip light fixture; and
b) a LED light engine body attached to the adapter ends, the linear LED light engine body comprising a linear housing and an array of LEDs within the linear housing that is electrically coupled to power connections through the elbow or end pieces.

2. The system of claim 1, further comprising a quick connect chord that provides electrical connections to electrically connect the elbow or end pieces to a power source.

3. The system of claim 1, wherein the linear LED light engine body has a tubular-shaped cross-section.

4. The system of claim 1, wherein the linear LED light engine body includes and internal LED driver circuit electrically coupled to the array of LEDs and the elbow or end pieces.

5. The system of claim 1, wherein the elbow or end pieces have electrical wires passing through elbow bracket or end piece and that terminate with contacts at the adapter ends and/or the rectangular clip ends.

6. A LED light system comprising an LED light engine comprising and linear housing with an array of LEDs and LED driver circuit contained therein, elbow or end pieces attached to opposed ends of the linear housing, the elbow or end pieces each having clip ends that fit into lamp holder apertures of existing strip light fixtures, and electrical connections that pass through the elbow or end pieces and that couple to the LED driver circuit for powering the LED array from a power connection or power source.

7. The LED light system of claim 6, further comprising a quick connect chord that provides electrical connections to electrically connect the elbow or end pieces to the power connection or power source.

8. The LED light system of claim 6, wherein the linear housing has a tubular-shaped cross-section.

9. A method for making a LED lighting system comprising:
a) forming a linear housing with and array of LEDs and LED driver circuit electrical coupled to the array of LEDs contained therein;
b) forming curved or angled elbow bracket or end pieces with clip ends, attachment ends and wire connections therein and terminating at/or near the clip ends; and
c) electrically coupling the LED driver circuit to the wire connections at/or near ends of the attachment ends and connecting opposed ends of the linear housing to the attachment ends of the curved or angled elbow bracket or end pieces.
